(19) United States
(12) Patent Application Publication
(10) Pub. No.: US 2010/0225374 A1
(43) Pub. Date: Sep. 9, 2010

(54) LOW NOISE MIXER

(75) Inventors: Hans Peter Forstner, Steinhoering (DE); Shoujun Yang, Linz (AT); Guenter Haider, Linz (AT)

Correspondence Address: ESCHWEILER & ASSOCIATES LLC, 629 EUCLID AVENUE, SUITE 1000, NATIONAL CITY BUILDING, CLEVELAND, OH, 44114, US

(73) Assignee: Infineon Technologies AG, Neubiberg (DE)

(21) Appl. No.: 12/399,773

(22) Filed: Mar. 6, 2009

(51) Int. Cl. G06G 7/12; G06G 7/14

(52) U.S. Cl. 327/361; 327/355

(57) ABSTRACT

One embodiment relates to a mixer for providing a mixed output signal. The mixer includes a radio-frequency (RF) stage, first and second power dividers, and first and second frequency-conversion stages. The RF stage includes a first differential pair. The first power divider is coupled to a first transistor of the first differential pair, and the second power divider is coupled to a second transistor of the first differential pair. The first frequency-conversion stage, which is adapted to provide a first converted-frequency signal, includes a second differential pair coupled to the second power divider and a third differential pair coupled to the first power divider. The second frequency-conversion stage, which is adapted to provide a second converted-frequency signal, includes a fourth differential pair coupled to the second power divider and a fifth differential pair coupled to the first power divider. Other techniques are also provided.

### FIELD OF DISCLOSURE

The present disclosure relates generally to methods and systems related to radio frequency (RF) devices, and more particularly to frequency conversion circuits.

### BACKGROUND

In telecommunications, mixers are circuits that receive two input signals and multiply them together to provide an output signal having a different frequency. In this manner, mixers can facilitate frequency up-conversion or down-conversion for an input signal.

For example, in wireless communication systems, radio-frequency (RF) signals are often transmitted at high frequencies, which are more effective at communicating wireless data than lower frequency signals. While these high-frequency RF signals tend to more effectively communicate data, the frequencies of the RF signals are so high that they cannot be processed by digital processors unless their frequencies are reduced. Therefore, on the receiver side, mixers are often used to reduce the frequency of received RF signals so they can be processed by digital baseband circuitry, such as a baseband processor. Conversely, on the transmitter-side, mixers are often used to increase the frequency of digital signals so they can be transmitted wirelessly as RF signals.

Due to the high frequencies at which mixers operate, high-speed semiconductors are typically used to fashion mixers. While these high-speed semiconductors are capable of switching reliably at high frequencies, they often suffer from a shortcoming in that they deliver only a small voltage swing at the output of the mixer while still maintaining linear gain. If the voltage swing were to be increased beyond this small voltage, the gain of the mixer would saturate causing undesirable non-linearity. Previous mixers have attempted to achieve linearity by reducing conversion gain by feedback or degeneration. While these approaches may have some advantages, they suffer from a shortcoming in that if any noise is present on the output of the mixer, the noise becomes a major concern for downstream components. Therefore, a need exists for a high gain, highly linear mixer.

### SUMMARY

The following presents a simplified summary. This summary is not an extensive overview, and is not intended to identify key or critical elements. Rather, the primary purpose of the summary is to present some concepts in a simplified form as a prelude to the more detailed description that is presented later.

One embodiment relates to a mixer for providing a mixed output signal. The mixer includes a radio-frequency (RF) stage, first and second power dividers, and first and second frequency-conversion stages. The RF stage includes a first differential pair. The first power divider is coupled to a first transistor of the first differential pair, and the second power divider is coupled to a second transistor of the first differential pair. The first frequency-conversion stage, which is adapted to provide a first converted-frequency signal, includes a second differential pair coupled to the second power divider and a third differential pair coupled to the first power divider. The second frequency-conversion stage, which is adapted to provide a second converted-frequency signal, includes a fourth differential pair coupled to the second power divider and a fifth differential pair coupled to the first power divider. Other techniques are also provided.

The following description and annexed drawings set forth in detail certain illustrative aspects and implementations. These are indicative of only a few of the various ways in which the principles disclosed may be employed.

### BRIEF DESCRIPTION OF THE DRAWINGS

FIG. 1 depicts an embodiment of a frequency conversion circuit in accordance with some embodiments.

FIG. 2 depicts a more detailed embodiment of a mixer.

FIG. 3 depicts a more detailed embodiment of a mixer.

FIG. 4 depicts an embodiment of a receiver.

FIG. 5 depicts an embodiment of an IQ-type receiver.

FIG. 6 depicts a frequency modulated continuous wave (FMCW) radar system in which a radar transceiver detects information about a target.

FIG. 7 depicts an example of frequency ramps used by a FMCW radar transceiver.

FIG. 8 depicts voltage waves that exhibit time-varying frequencies used by a FMCW transceiver.

FIG. 9 depicts a more detailed block diagram of a radar transceiver.

FIG. 10 shows a flow chart illustrating a method in accordance with some aspects of this disclosure.

### DETAILED DESCRIPTION

One or more implementations are described with reference to the attached drawings, where like reference numerals are used to refer to like elements throughout. It will be appreciated that nothing in this specification is admitted as prior art.

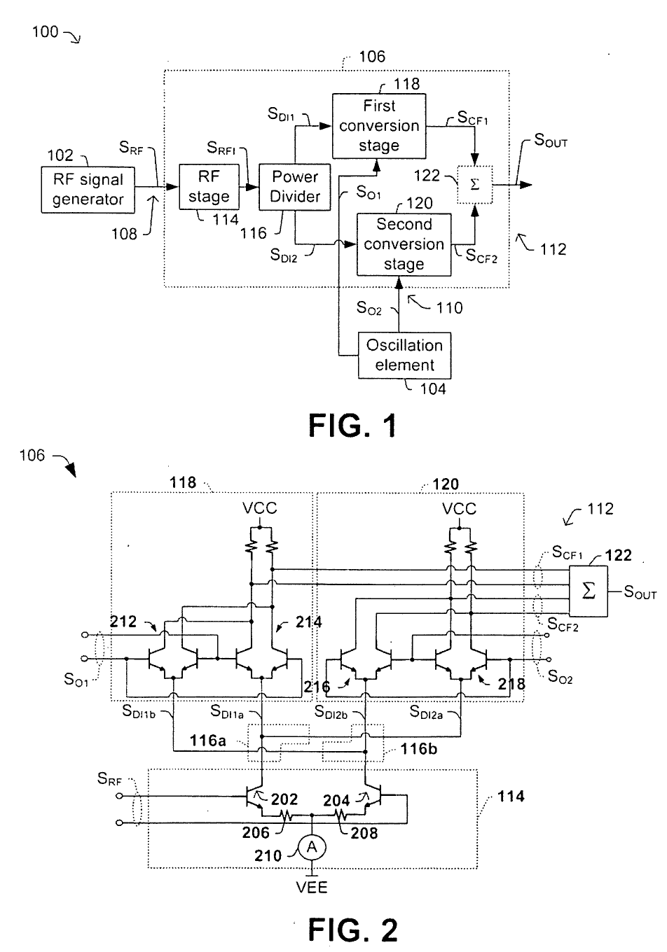

As the inventors have appreciated, high linearity is desirable to make mixers resistant against interference. FIG. 1 depicts a frequency conversion circuit 100 in accordance with some embodiments of the invention. The frequency conversion circuit 100 includes a radio frequency (RF) signal generator 102, an oscillation element 104, and a mixer 106. A first input 108 of the mixer 106 is coupled to the RF signal generator 102, and a second input 110 of the mixer 106 is coupled to the oscillation element 104. Internally, the mixer 106 includes a radio-frequency (RF) stage 114, a power divider 116, a first frequency-conversion stage 118, a second frequency-conversion stage 120, and an optional summation element 122.

For purposes of illustration, an example is described below where the mixer 106 receives on its first input 108 a RF signal, S_{RF}, having a frequency of 60 GHz. The mixer 106 also receives on its second input 110 oscillation signals, S_{O1}, S_{O2}, which share an oscillation frequency of 58 GHz. The mixer 106 multiplies these signals together, thereby facilitating down-conversion to a 2 GHz mixed output signal, S_{OUT}. The specified frequencies, which are merely examples, are provided for purposes of clarity, and it will be appreciated that operation of the frequency conversion circuit 100 is equally applicable to other frequencies. For example, in other embodiments, the mixer 106 can down-convert an RF signal in the millimeter frequency band, where millimeter frequency band range from about 30 gigahertz (GHz) to about 300 GHz. Non-millimeter wireless signals also fall within the scope of this disclosure.

During operation, the RF stage 114 receives the RF signal, S_{RF}, which exhibits an RF frequency, f_{RF}, of about 60 GHz in this example. Based on this RF signal, the RF stage 114 generates RF current signal, S_{RFI}, therefrom.

The power divider 116 divides the current signal, S_{RFI}, into divided power signals S_{DP1}, S_{DP2} and passes these signals to the first and second frequency-conversion stages 118, 120. The divided power signals S_{DP1}, S_{DP2} still exhibit the frequency, f_{RF}, which in this example is about 60 GHz.

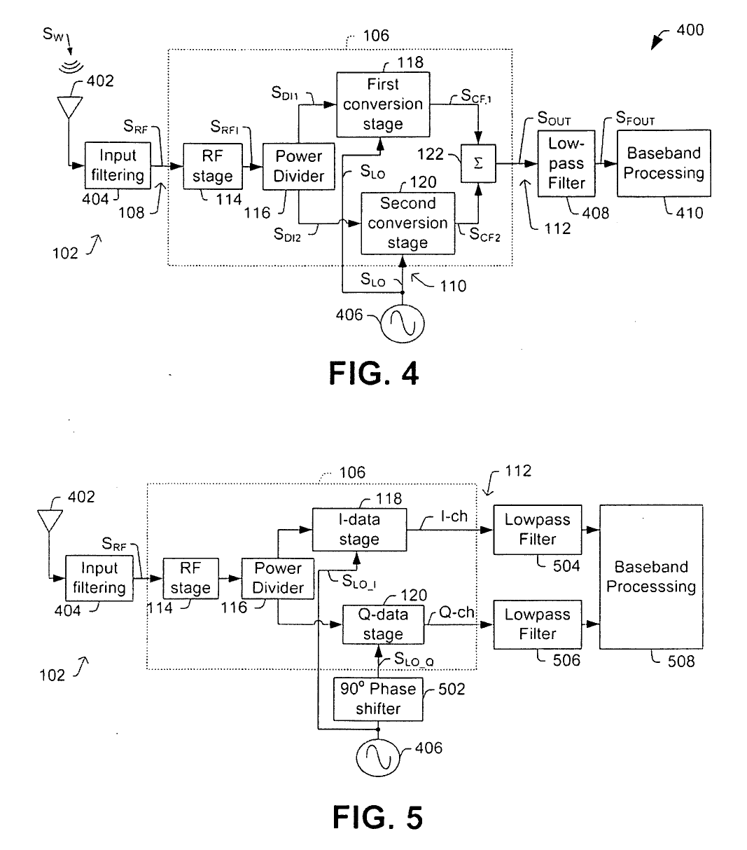

The oscillation element 104 provides oscillation signals, S_{O1}, S_{O2} to the first and second frequency conversion stages 118, 120, respectively. Depending on the implementation, the oscillation signals, S_{O1}, S_{O2}, may be in phase with one another (see e.g., FIG. 4) or may be out of phase with one another (see e.g., FIG. 5). In this example, the oscillation signals S_{O1}, S_{O2} have a frequency f_{O} of about 58 GHz.

By “multiplying” a divided power signal with an oscillation signal, each frequency-conversion stage delivers a converted-frequency signal having frequency components f_{RF}±f_{O}. In this manner, the first frequency-conversion stage 118 delivers a first converted-frequency signal S_{CF1} having a first frequency component of about 118 GHz (i.e., f_{RF}+f_{O}) and a second frequency component of about 2 GHz (i.e., f_{RF}−f_{O}). Other higher order frequency components may also be included, but are omitted in this discussion for simplicity and clarity. Similarly, the second frequency-conversion stage 120 delivers a second converted-frequency signal S_{CF2} having frequency components of about 118 GHz (i.e., f_{RF}+f_{O}) and about 2 GHz (i.e., f_{RF}−f_{O}).

If present, the summation element 122 receives the first and second converted-frequency signals S_{CF1}, S_{CF2}, which can be correlated or in-phase, and sums the first and second signals S_{CF1}, S_{CF2}. In this manner, the summation element 122 provides a mixed output signal, S_{OUT}, where the mixed output signal has an amplitude greater than that of each of the first and second converted-frequency signals S_{CF1}, S_{CF2}. For example, in one embodiment, the voltage magnitude of S_{CF1} is about 2 Volts (V), the voltage magnitude of S_{CF2} is about 2 V, and the mixed output signal S_{OUT} has a voltage magnitude of about 4 V.

FIG. 2 shows a more detailed depiction of a mixer 106 in accordance with some embodiments. In this embodiment, the RF stage 114 comprises a first differential pair having a first transistor 202 and a second transistor 204. Resistors 206, 208 are coupled to emitters of first and second transistors 202, 204, respectively. A current source 210 is also coupled to and between the resistors 206, 208 and a reference voltage VEE. Typically, the RF signal provided to the control terminal of the first transistor 202 is 180° out-of-phase with the RF signal provided to the control terminal of the second transistor 204.

The first power divider 116a is coupled to the collector of the first transistor 202. The second power divider 116b is coupled to the collector of the second transistor 204. In some embodiments, the first and second power dividers 116a, 116b comprise an impedance matching network, which is tuned to be purely reactive. For example, the first and second power dividers can include transmission lines, such as microstrip, coplanar, stripline, etc., for this purpose. Such impedance matching networks may help to limit power dissipation through the mixer 106, thereby increasing the noise margin and improving performance beyond what has previously been achievable.

Within the first frequency conversion stage 118, a second differential pair 212 is coupled to the second power divider 116b and a third differential pair 214 is coupled to the first power divider 116a. Within the second frequency conversion stage 120, a fourth differential pair 216 is coupled to the second power divider 116b and a fifth differential pair 218 is coupled to the first power divider 116a. As previously mentioned, the first and second oscillation signals S_{O1}, S_{O2} may be in-phase or out-of phase, depending on the implementation, but in either case serve to facilitate generation of first and second converted-frequency signals S_{CF1}, S_{CF2} to the output 112.

In many embodiments, the transistors in the RF stage 114, and first and second frequency conversion stages 118, 120 are disposed on a substrate of high-speed semiconductor material, such as a binary semiconductor compound (e.g., SiGe, GaAs), a tertiary semiconductor compound (e.g., AlGaAs, GaAsP), or a higher-order semiconductor compound. Although silicon can also be used in some implementations, these high-speed semiconductor materials are advantageous because they provide faster switching times compared to silicon. Unfortunately, such high-speed semiconductor materials are often more expensive and/or more difficult to work with than silicon. Therefore, to ease manufacturing and costs while still delivering high-speed operation, in some embodiments where the RF input 114 and first and second frequency conversion stages 118, 120 comprise high-speed semiconductor materials, the summation element 122 (which can process lower frequency signals) may be include silicon devices and/or passive elements that are more cost effective to manufacture. Not only are these silicon devices more cost effective to manufacture, but they also provide a potentially higher amplitude output signal amplitude due to higher breakdown voltages, thereby providing the mixer with an increased linear range relative to prior solutions.

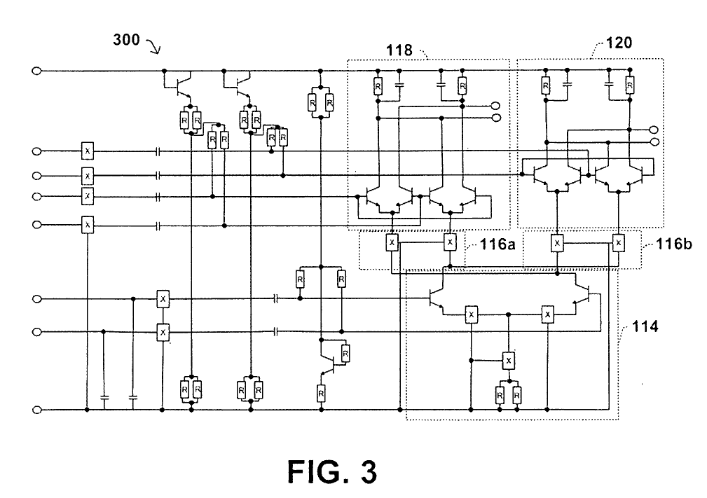

FIG. 3 shows another more detailed embodiment that includes biasing circuitry 300 that includes resistive loads (R) and capacitors. In addition, this embodiment shows various nodes where impedance matching networks (X), such as transmission lines, are included.

The mixers 106 described above can be used in many electronic applications. To highlight some particular implementations that may be useful, several examples are discussed below with respect to FIGS. 4-9. These electronic applications are not limiting in any way, and other electronic applications also fall within the scope of this disclosure.

FIG. 4 depicts a receiver 400 including a mixer in accordance with some embodiments. The receiver 400 includes an antenna 402 having an antenna port coupled to an input filtering element 404, which is coupled to a first input 108 of a mixer 106. A second input 110 of the mixer 106 is coupled to an oscillation element 406. In addition, an output 112 of the mixer 106 is coupled to a filter element 408 (e.g., low pass filter), which is coupled to baseband processing circuitry 410. Internally, the mixer 106 includes a RF stage 114, a power divider 116, a first frequency-conversion stage 118, a second frequency-conversion stage 120, and a summation element 122, as previously discussed (see e.g., FIG. 1).

A more detailed mode of operation consistent with FIG. 4's receiver 400 is now set forth. Again, for clarity, example frequency values are described consistent with those previously discussed. During operation, the antenna 402 receives a wireless signal, S_{w}, in the form of a time-varying voltage. In this example, the wireless signal, S_{w}, has a wanted frequency component of about 60 GHz, although it often includes other unwanted frequency components.

After the wireless signal, S_{w}, is received by the antenna 402, the input filtering element 404, which can filter out unwanted frequencies, passes an RF signal, S_{RF}, to the mixer's first input 108. In the illustrated example, the RF signal, S_{RF}, has a frequency f_{RF} of about 60 GHz.

Based on the RF signal, S_{RF}, and the oscillation signal SLO (which in this case is delivered in-phase to the first and second frequency-conversion stages 118, 120); the RF stage 114 generates a mixed output signal Sₒᵤₜ. Because the summation element 122 receives the first and second converted-frequency signals S_{CF1}, S_{CF2}, which are correlated or in-phase in this example, the mixed output signal S_{OUT} has an amplitude greater than each of the first and second converted-frequency signals S_{CF1}, S_{CF2}. For example, in one embodiment, the voltage magnitude of S_{CF1} is about 2 Volts (V), the voltage magnitude of S_{CF2} is about 2 V, and the mixed output signal S_{OUT} has a voltage magnitude of about 4V.

After the summation element 122 delivers the mixed output signal, S_{OUT}, the filter element 408 can eliminate unwanted frequency components. Thus, in this example, the filter element 408 removes the 118 GHz frequency component, and passes a filtered output signal S_{FOUT}, which includes the wanted 2 GHz frequency component, to the baseband processing circuitry 410. Thus, the illustrated example is consistent with an intermediate frequency (IF) receiver. Often, another downconversion stage (not shown) reduces the filtered output signal S_{FOUT} down to a baseband signal which is processed by the baseband processing circuitry 410. A digital to analog converter (DAC) can be present upstream or downstream of the another downconversion stage to digitize the filtered output signal S_{FOUT}.

Although FIG. 4 shows an example of a direct conversion receiver, other embodiments can include IF-, low IF-, or sliding IF-receivers. In such embodiments, additional down-conversion stages can be included prior to the baseband processing circuitry 410.

Referring now to FIG. 5, one can see another embodiment of an IQ-type receiver. In this embodiment, a 90° phase shift module provides a phase shift between an I-data LO stage and a Q-data LO stage. The summation element has been removed, and instead each of the I-data LO stage and Q-data LO stage are coupled directly to filter elements 504, 506. In this manner, an I-channel delivers in-phase data (I-data) and a Q-channel delivers quadrature data (Q-data) through the filter elements 504, 506 to the baseband processing circuitry 508. At some point in the baseband processing circuitry, the I-data and Q-data are combined, often after a DAC.

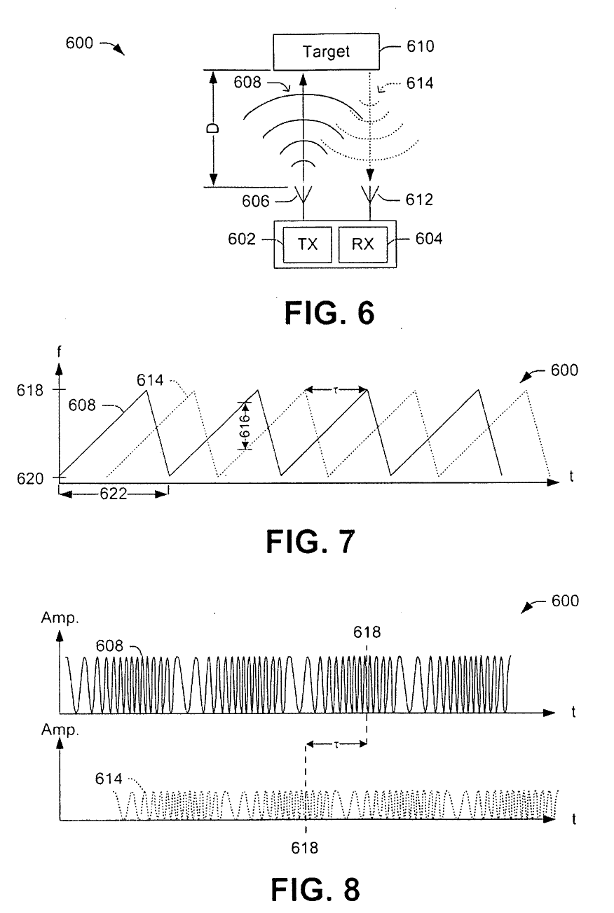

FIGS. 6-9 relate to a radar system, such as an automotive radar system or any other type of radar system. FIG. 6 depicts a FMCW radar system 600 that include a transmitter 602 and a receiver 604. The transmitter 602 includes an antenna 606 for sending a transmitted signal 608, such as a radio wave or other electromagnetic wave, towards a target 610. Similarly, the receiver 604 includes an antenna 612 for receiving a scattered signal 614 that is reflected from the target 610. In other un-illustrated embodiments, a single antenna can be used for both transmission and reception and/or pulsed radar systems can be used.

To determine a distance to the target, the transmitter 602 sends the transmitted signal 608 as a frequency ramp whose frequency varies as a function of time, for example, as shown in FIGS. 7-8. As shown in these figures, after the transmitted signal 608 is sent, there is some time delay, τ, before the scattered signal 614 is received back at the receiver 604. At the time when the scattered signal 614 is received, a frequency difference 616 can be measured between the transmitted signal 608 and the scattered signal 614. This frequency difference 616 is often used to help determine range, velocity, or other information about the target.

More particularly, FIG. 7 shows frequency ramps for the transmitted signal 608 and scattered signal 614 as a function of time. The frequency ramps have a maximum frequency 618, minimum frequency 620, and period 622. FIG. 8 shows the voltage waves for the transmitted signal 608 and scattered signal 614 as a function of time, where the frequency of the voltage waves changes over time to correspond (roughly) to FIG. 7. Because the transmitted and scattered signals 608, 614 travel a total distance of 2D at the speed of light, c (i.e., from transceiver to target and back); the delay, τ, will be directly proportional to the distance, D, to the target 610 (i.e., τ=2D/c). Thus, by measuring the delay, τ, between the transmitted and scattered signals 608, 614, the FMCW radar system 600 can monitor the distance to the target 610.

The FMCW radar system 600 can monitor the velocity of the target by using a series of different ramps, or by tracking the distance as a function of time. In this way, the FMCW radar system 600 can determine the distance and velocity of the target 610. In these and other embodiments, Doppler shift or other effects may also be used to determine the distance, velocity, and/or other information about the target.

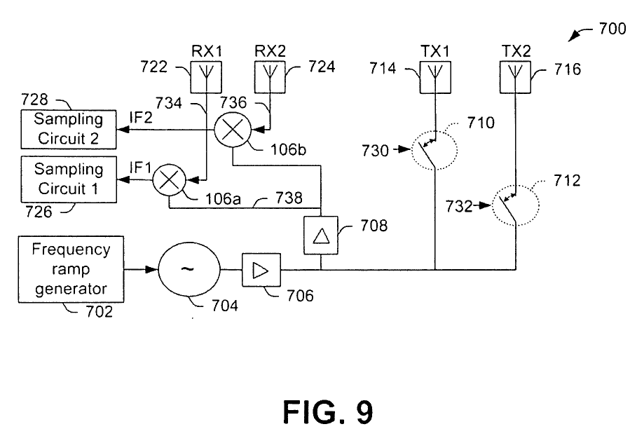

Turning now to FIG. 9, circuitry 700 for a radar transceiver is depicted. As shown, the circuitry 700 includes a frequency ramp generator 702; a voltage controlled oscillator (VCO) 704; an output buffer 706 and a local oscillator (LO) buffer 708; first and second switches 710, 712 associated with first and second transmit antennas 714, 716, respectively; first and second mixers 106a, 106b associated with first and second receive antennas 722, 724, respectively; and first and second sampling circuits 726, 728 associated with the first and second receive channels IF1, IF2, respectively.

During operation, the frequency ramp generator 702 provides a series of frequency ramps to the VCO 704. These frequency ramps can facilitate FMCW radar operation in one embodiment.

The VCO 704 provides a time-varying analog voltage to output buffer 706, which provides outgoing signals towards the first and second switches 710, 712.

The first and second switches 710, 712, respectively, selectively transmit the outgoing signals over the first and second antennas 714, 716, respectively, as a function of first and second control signals 730, 732, respectively. In one embodiment, the first and second switches are power amplifiers. After the outgoing signals are transmitted, they may reflect from a target, and be received as first and second scattered signals 734, 736 at the first and second receive antennas 722, 724, respectively.

The first mixer 106a can mix the first scattered signal 734 with an LO signal 738 to provide a first down-converted or baseband signal IF1. Similarly, the second mixer 106b can mix the second scattered signal 736 with the LO signal 738 to provide a second down-converted or baseband signal IF2. These down-converted or baseband signals IF1, IF2 may contain phase, frequency, and/or amplitude information related to the position, velocity, and/or incident angle of the target from which the scattered signals reflected.

The down-converted signals IF1, IF2 are then processed by the first and second sampling circuits 726, 728, respectively.

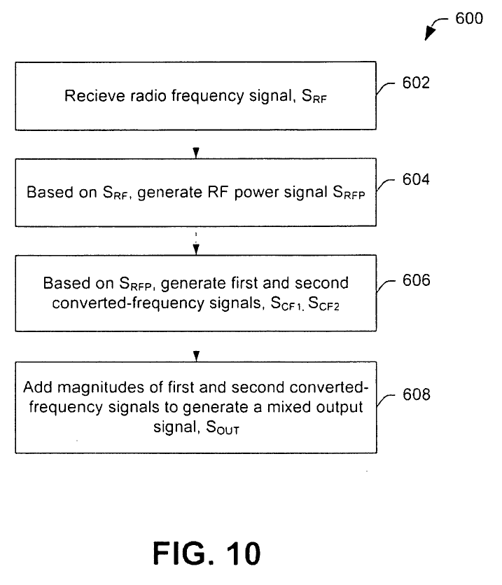

Now that some examples of systems have been discussed, reference is made to FIG. 10, which shows a method 1000 in flowchart format. While this method is illustrated and described below as a series of acts or events, the present invention is not limited by the illustrated ordering of such acts or events. For example, some acts may occur in different orders and/or concurrently with other acts or events apart from those illustrated and/or described herein. In addition, not all illustrated acts may be required. Further, one or more of the acts depicted herein may be carried out in one or more separate acts or phases.

At 1002, a radio frequency (RF) input signal S_{RF} is provided. For example, in some embodiments the RF input signal could be provided with a frequency ranging from about 30 GHz to about 300 GHz.

At 1004, based on S_{RF}, a divided current signal S_{RFI} is generated. Often, this divided current signal exhibits the frequency of the RF input signal.

At 1006, based on S_{RFI}, first and second converted-frequency signals, S_{CF1}, S_{CF2} are generated. Often, the first and second converted-frequency signals have a first frequency component equal to f_{RF}−f_{LO} and a second frequency component equal to f_{RF}+f_{LO}.

At 1008, the magnitudes of the first and second converted-frequency signals are added together to generate a mixed output signal, S_{OUT}. The mixed output signal has a magnitude that is greater than that of the first and second converted-frequency signals.

Although one or more implementations has been illustrated and/or discussed above, alterations and/or modifications may be made to these examples without departing from the spirit and scope of the appended claims. For example, although some embodiments have been illustrated and described above in which a mixer is comprised of BJTs, it will be appreciated that other types of transistors, including but not limited to: metal oxide semiconductor field effect transistors (MOSFETs), junction gate field effect transistors (JFETs), insulated gate field effect transistors (IGFETs), insulated gate bipolar transistors (IGBTs); constitute legal equivalents of these BJTs. These transistors may be made of silicon in some embodiments, but may also be made of other materials, including but not limited to: germanium, gallium arsenide, silicon carbide, and others.

In addition, although some mixers above have been described in the context of performing frequency down-conversion in a receiver, in other embodiments these mixers can perform frequency up-conversion in a transmitter. Further, the mixers described above can also be implemented as part of a feedback loop, such as in a frequency divider or phase-locked loop, for example, or as part of other electronic circuits or systems.

As used in this disclosure, the term “couple” (or derivatives thereof) is intended to mean either an indirect or direct electrical connection. Thus, if a first device couples to a second device, that connection may be through direct electrical connection, or through an indirect electrical connection via other devices and connections. Although various numeric values are provided herein, these values are just examples and do not limit the scope of the disclosure. Also, all numeric values are approximate.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in either the detailed description and the claims, such terms are intended to be inclusive in a manner similar to the term “comprising”.

1-13. (canceled)

14. A mixer for providing a mixed output signal, comprising:
a radio-frequency (RF) stage comprising a first differential pair, wherein the first differential pair comprises a first transistor and a second transistor;
a first frequency-conversion stage adapted to provide a first converted-frequency signal, the first frequency-conversion stage comprising: a second differential pair of transistors coupled to the second transistor and a third differential pair of transistors coupled to the first transistor;
a second frequency-conversion stage adapted to provide a second converted-frequency signal, the second frequency-conversion stage comprising: a fourth differential pair of transistors coupled to the second transistor and a fifth differential pair of transistors coupled to the first transistor.

15. The mixer of claim 14, where the first and second power dividers comprise transmission line.

16. The mixer of claim 14, further comprising:
a summation element adapted to sum the first converted-frequency signal with the second converted-frequency signal, thereby providing the mixed output signal.

17. The mixer of claim 16, where the first and second transistors of the first differential pair of transistors are formed on a substrate comprising at least one of the following: a binary-compound semiconductor, a tertiary-compound semiconductor, or a higher-order compound semiconductor.

18. The mixer of claim 17, where the summation element comprises semiconductor devices formed on a silicon substrate.

19. A method of providing a mixed output signal, comprising:
providing a radio frequency input signal exhibiting an RF frequency;
based on the radio frequency input signal, generating a first current signal from a first transistor of a differential pair of transistors and generating a second current signal from a second transistor of the differential pair of transistors;
using a first frequency conversion stage to generate a first converted-frequency signal based on the first and second current signals, wherein the first frequency converted signal includes a converted-frequency that differs from the RF frequency;
using a second frequency conversion stage to generate a second converted-frequency signal based on the first and second current signals, wherein the second frequency converted signal includes the converted-frequency that differs from the RF frequency; and
summing magnitudes of the first and second converted-frequency signals to generate a mixed output signal.

20. The method of claim 19, where generating the first and second converted frequency signals is also based on an oscillation signal having a oscillation frequency different from the RF frequency.

21. The method of claim 20, where the first and second converted-frequency signals each comprise:
a first frequency component equal to a sum of the RF frequency plus the oscillation frequency; and
a second frequency component equal to a difference between the RF frequency and the oscillation frequency.

22. The method of claim 19, where the mixed output signal has a magnitude that is greater than magnitudes of the first and second converted-frequency signals.

23. (canceled)
